(19) United States
(12) Patent Application Publication
(10) Pub. No.: US 2024/0087029 A1
(43) Pub. Date: Mar. 14, 2024

(54) SYSTEMS AND METHODS FOR AN ARTIFICIAL INTELLIGENCE ENABLED PROCESSING OF PERSONALIZED AUTONOMOUS PORTFOLIOS

(71) Applicant: Michael Carter, Wayne, PA (US)

(72) Inventor: Michael Carter, Wayne, PA (US)

(21) Appl. No.: 18/463,947

(22) Filed: Sep. 8, 2023

Related U.S. Application Data
(60) Provisional application No. 63/404,779, filed on Sep. 8, 2022.

(51) Int. Cl. G06Q 40/06

(52) U.S. Cl. CPC G06Q 40/06

(57) ABSTRACT

A portfolio completion (PC) computing device is disclosed. The PC computing device is configured to: (1) retrieve, from a memory device, historical financial data, historical value parameters data, and historical portfolio data associated with a plurality of customers, (2) train a PC model relating the historical financial data to the historical portfolio data and the historical value parameters data, wherein the PC model predicts a customized portfolio based upon user financial data and user value parameters data, (3) store the trained PC model in the memory device, (4) receive customer financial data and customer value parameter data associated with a customer, and (5) predict a customized allocation portfolio for the customer using the trained PC model based upon the received customer financial data and customer value parameter data.

### PRIORITY

This application claims priority to U.S. Provisional Application No. 63/404,779, filed Sep. 8, 2022, entitled “ARTIFICIAL INTELLIGENCE ENABLED PROCESSING OF PERSONALIZED AUTONOMOUS PORTFOLIOS,” which is hereby incorporated by reference as if submitted in its entirety.

### FIELD OF THE INVENTION

The present invention relates to artificial intelligence modeling, and, more particularly, provisioning of personalized autonomous portfolios based on artificial intelligence modeling.

### BACKGROUND

Wealth management is an investment advisory service that provides financial management and wealth advisory services to a wide array of clients. Wealth management incorporates structuring and planning wealth to assist in growing, preserving, and protecting wealth, while also passing it onto the family in a tax-efficient manner and in accordance with their wishes.

Financial technology, more commonly known as “fintech,” includes the emergence of a whole range of new technology used to improve and automate the delivery of financial services. Wealth managers are expected to increase technology spending to reach approximately $24 billion annually by 2023, according to a 2020 research study by Celent, the technology advisory arm of Oliver Wyman. Much of this technology spending is spent on planning applications or mass customer online acquisition sites.

Current technology wealth management solutions include robo-advisors, planning applications, and portfolio tools. However, each of these current solutions have significant drawbacks. For example, with a robo-advisor, there is no human support, narrow investment choices are provided, and not all of your investments may be considered. With planning applications, only one plan is provided, and is incapable of updated in response to a change in a customer's financial situation. In addition, portfolio tools are not integrated to the holistic, living plan or the right advisors. Therefore, systems and methods for generating wealth management portfolios which incorporate real-time data from disparate sources are highly sought after and desirable.

### BRIEF SUMMARY OF THE INVENTION

In one aspect, portfolio completion (PC) computing device comprising at least one processor in communication with a memory device is disclosed. The at least one processor configured to retrieve, from the memory device, historical financial data, historical value parameters data, and historical portfolio data associated with a plurality of customers. The at least one processor is further configured to train a PC model relating the historical financial data to the historical portfolio data and the historical value parameters data, wherein the PC model predicts a customized portfolio based upon user financial data and user value parameters data and store the trained PC model in the memory device. The at least one processor is further configured to receive customer financial data and customer value parameter data associated with a customer and predict a customized allocation portfolio for the customer using the trained PC model based upon the received customer financial data and customer value parameter data.

In another aspect, computer-implemented method for generating a customized allocation portfolio is disclosed. The computer-implemented is implemented using a system including a portfolio completion (PC) computing device including a processor communicatively coupled to a memory device. The computer-implemented method comprises retrieving, from the memory device, historical financial data, historical value parameters data, and historical portfolio data associated with a plurality of customers. The computer-implemented method further comprises training a PC model relating the historical financial data to the historical portfolio data and the historical value parameters data, wherein the PC model predicts a customized portfolio based upon user financial data and user value parameters data and storing the trained PC model in the memory device.

The computer-implemented method further comprises receiving customer financial data and customer value parameter data associated with a customer and predicting a customized allocation portfolio for the customer using the trained PC model based upon the received customer financial data and customer value parameter data.

In yet another aspect, at least one non-transitory computer-readable storage medium having computer-executable instructions stored thereon is disclosed. The computer-executable instructions, when executed by a processor of a portfolio completion (PC) computing device, cause the processor to retrieve, from the memory device, historical financial data, historical value parameters data, and historical portfolio data associated with a plurality of customers. The computer-executable instructions further cause the processor to train a PC model relating the historical financial data to the historical portfolio data and the historical value parameters data, wherein the PC model predicts a customized portfolio based upon user financial data and user value parameters data and store the trained PC model in the memory device. The computer-executable instructions further cause the processor to receive customer financial data and customer value parameter data associated with a customer and predict a customized allocation portfolio for the customer using the trained PC model based upon the received customer financial data and customer value parameter data.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description refers to the accompanying figures in which:

FIG. 1 illustrates a simplified block diagram of a computing system, according to an embodiment of the present disclosure.

FIG. 2 illustrates an exemplary configuration of a client computing device as shown in FIG. 1, according to an embodiment of the present disclosure.

FIG. 3 illustrates an exemplary configuration of a server computing device as shown in FIG. 1, according to an embodiment of the present disclosure.

FIG. 4 illustrates a flow diagram of a process for predicting a customized allocation portfolio for the customer, according to an embodiment of the present disclosure.

FIG. 5 illustrates a flow diagram of an exemplary process for re-training a model, according to an embodiment of the present disclosure.

FIG. 6 depicts a flow diagram of an exemplary process for matching a customer with a financial advisor, according to an embodiment of the present disclosure.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

The present embodiments may relate to, inter alia, systems and methods for an Artificial Intelligence (AI) enabled provisioning of personalized autonomous portfolios. In some embodiments, the personalized autonomous portfolios may comprise a plurality of recommended investments for a customer according to a customer's goals, risk tolerance, and investment horizon. Further, the systems and methods disclosed herein may route customized portfolios to financial advisors and/or other financial institutions that map to the customer's values. Therefore, the systems and methods disclosed herein create a complete personalized portfolio based on a customer's financial data and values and route the personalized portfolio to financial advisors that align with the customer's values.

The systems and methods disclosed herein provide various technical solutions within the wealth management space, including but not limited to, (i) automatically provisioning personalized portfolios on demand and in real-time; (ii) incorporating data from disparate sources to generate the personalized portfolios; and (iii) providing a secure, centralized access point for generating a personalized portfolio.

### Exemplary Computing System

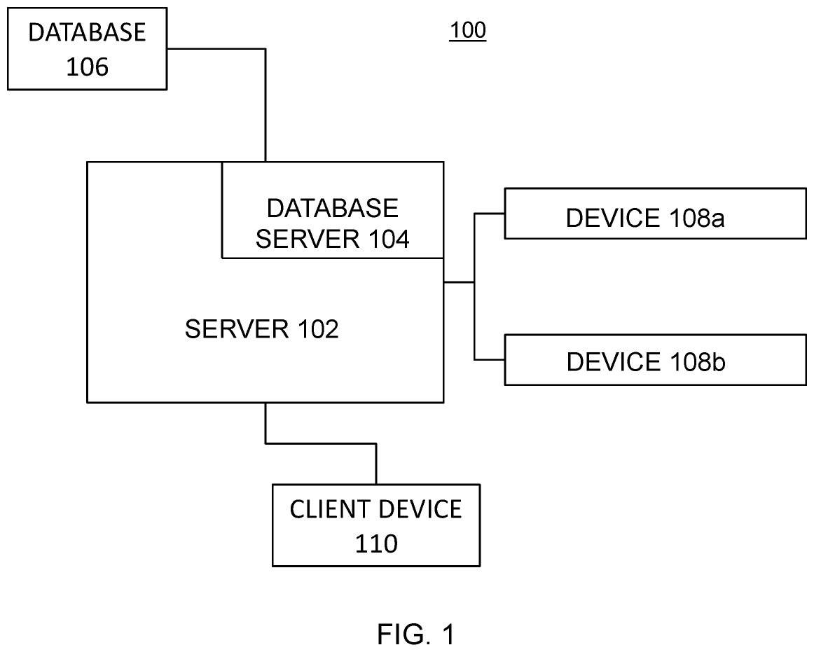

FIG. 1 illustrates a simplified block diagram of an exemplary system 100 for AI-enabled portfolio creation. As described below in more detail, server 102 (also known as a computer device 102), may be configured to integrate a planning application with an AI-enabled portfolio completion system as described herein.

In the exemplary embodiment, server 102 may be in communication with one or more user computing devices 108a-108n. User computing devices 108a-108n may be computers that include a web browser or a software application, which enables access to remote computer devices, such as server 102, using the Internet or other network. More specifically, user computing devices 108a-108n may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 108a-108n may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, user computing devices 108a-108n may be associated with different entities that may interact with one another on the network, such as developers (e.g., mobile application or software), network users or administrators, system users or administrators, or the like.

A database server 104 may be communicatively coupled to a database 106. In one embodiment, database 106 may include a copy of a training model for the AI-enabled portfolio completion system. Additionally, or alternatively, database 106 may include inputs received from a plurality of users via user computing devices 108a-108n. In some embodiments, database 106 may be located remotely from server 102. In some embodiments, database 106 may be accessible via a cloud-based computing system. In the exemplary embodiment, a user may access database 106 via a user computing device, such as one of computing devices 108a-108n, via server 102, as described herein.

In the exemplary embodiment, server 102 may be in communication with a plurality of computing devices, such as user computing devices 108a-108n. More specifically, server 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Server 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, server 102 may also be associated with a plurality of user computer device (not shown) that allow individual users to access server 102 and database 106. In some embodiments, server 102 may comprise of a plurality of computer devices working in concert.

### Exemplary Client Computing Device

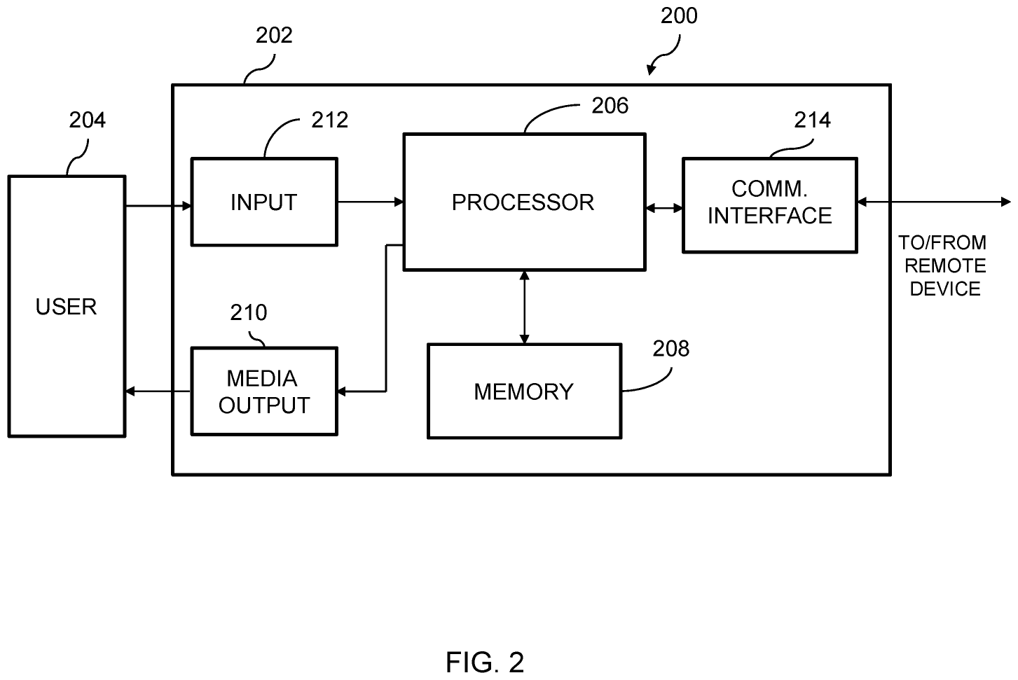

FIG. 2 illustrates a block diagram 200 of an exemplary client computing device 202 that may be used with the server computing device 102 shown in FIG. 1. Client computing device 202 may be, for example, at least one of user computing devices 108a-108n (shown in FIG. 1).

Client computing device 202 may be accessible to, and associated with, a user 204. Device 202 may include a processor 206 for executing instructions. In some embodiments, executable instructions may be stored in a memory area 208. Processor 206 may include one or more processing units (e.g., in a multi-core configuration). Memory area 208 may be any device allowing information such as executable instructions and/or other data to be stored and retrieved. Memory area 208 may include one or more computer readable media.

In one or more exemplary embodiments, client computing device 202 may also include at least one media output component 210 for presenting information to a user 204. Media output component 210 may be any component capable of conveying information to user 204. In some embodiments, media output component 210 may include an output adapter such as a video adapter and/or an audio adapter. An output adapter may be operatively coupled to processor 206 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones).

Client computing device 202 may also include an input device 212 for receiving input from a user 204. Input device 212 may include, for example, a keyboard, a pointing device, a mouse, a stylus, a touch sensitive panel (e.g., a touch pad or a touch screen), a gyroscope one or more sensors or an audio input device. A single component, such as a touch screen, may function as both an output device of media output component 210 and an input device of input device 212.

Client computing device 202 may also include a communication interface 214, which can be communicatively coupled to a remote device, such as computing device 102, shown in FIG. 1. Communication interface 214 may include, for example, a wired or wireless network adapter or a wireless data transceiver for use with a mobile phone network (e.g., Global System for Mobile communications (GSM), 3G, 4G, 5G, NFC, or Bluetooth) or other mobile data networks (e.g., Worldwide Interoperability for Microwave Access (WIMAX)). The systems and methods disclosed herein are not limited to any certain type of short-range or long-range networks.

Stored in memory area 208 may be, for example, computer readable instructions for providing a user interface to user 204 via media output component 210 and, optionally, receiving and processing input from input device 212. A user interface may include, among other possibilities, a web browser or a client application, such as a mobile application. Web browsers may enable users, such as user 204, to display and interact with media and other information typically embedded on a web page or a website.

Memory area 208 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are exemplary only, and are thus not limiting as to the types of memory usable for storage of a computer program.

### Exemplary Server Computing Device

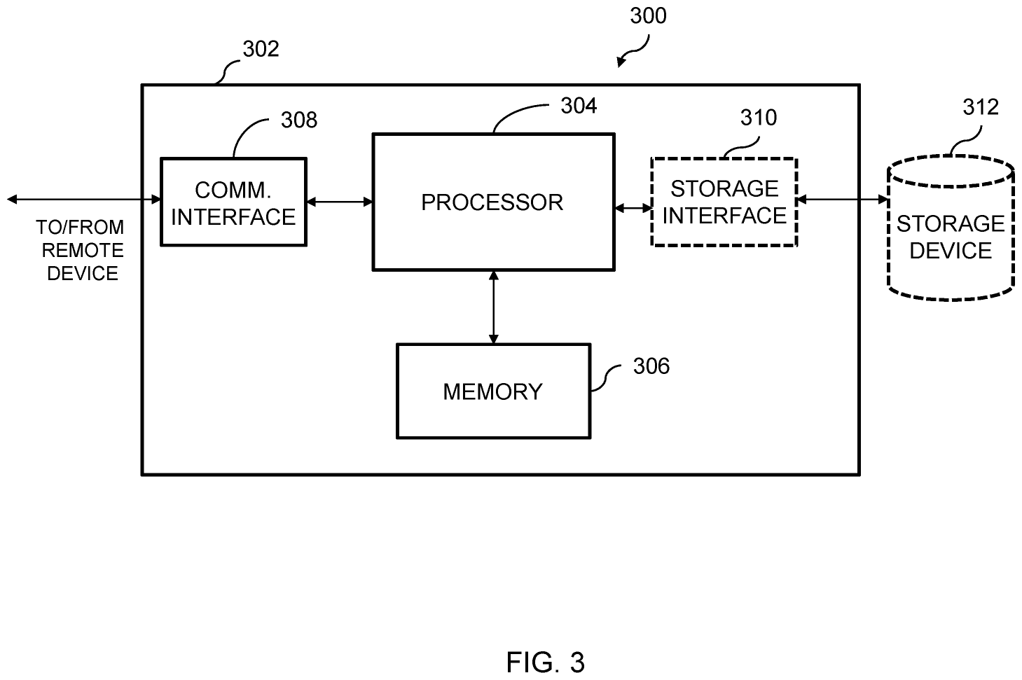

FIG. 3 depicts a block diagram 300 showing an exemplary server system 302. Server system 302 may be, for example, computing device 102 or database server 104 (shown in FIG. 1).

In exemplary embodiments, server system 302 may include a processor 304 for executing instructions. Instructions may be stored in a memory area 306. Processor 304 may include one or more processing units (e.g., in a multi-core configuration) for executing instructions. The instructions may be executed within a variety of different operating systems on server system 302, such as UNIX, LINUX, Microsoft Windows®, etc.

It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, Python, or other suitable programming languages, etc.).

Processor 304 may be operatively coupled to a communication interface 308 such that server system 302 may communicate with computing device 102 or client device 110 (all shown in FIG. 1), and/or another server system. For example, communication interface 308 may receive data from client device 110 via the Internet or a mobile network.

Processor 304 may also be operatively coupled to a storage device 312, such as database 106 (shown in FIG. 1), via a storage interface 310. Storage device 312 may be any computer-operated hardware suitable for storing and/or retrieving data. In some embodiments, storage device 312 may be integrated in server system 302. For example, server system 302 may include one or more hard disk drives as storage device 312.

In other embodiments, storage device 312 may be external to server system 302 and may be accessed by a plurality of server systems. For example, storage device 312 may include multiple storage units such as hard disks or solid-state disks in a redundant array of inexpensive disks (RAID) configuration. Storage device 312 may include a storage area network (SAN) and/or a network attached storage (NAS) system.

In some embodiments, processor 304 may be operatively coupled to storage device 312 via a storage interface 310. Storage interface 310 may be any component capable of providing processor 304 with access to storage device 312. Storage interface 310 may include, but is not limited to, an Advanced Technology Attachment (ATA) adapter, a Serial ATA (SATA) adapter, a Small Computer System Interface (SCSI) adapter, a RAID controller, a SAN adapter, a network adapter, and/or any component providing processor 304 with access to storage device 312.

Memory area 306 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types not to be considered limiting as to the types of memory usable for storage of the exemplary computing system.

### Exemplary Process for Generating a Customized Allocation Portfolio

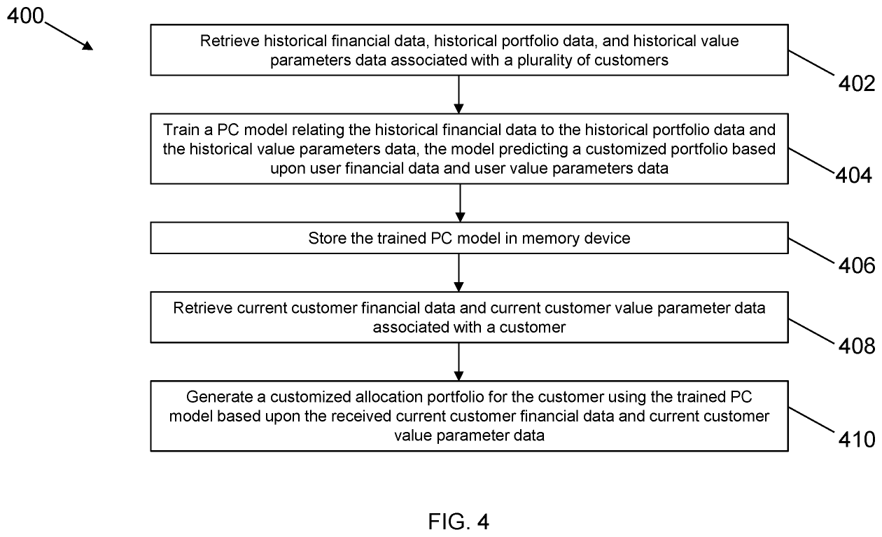

FIG. 4 depicts a flow diagram of an exemplary process for generating a customized allocation portfolio 400. Process 400 may be a computer-implemented process performed by one or more processors (e.g., processor 206 shown in FIG. 2 and/or processor 304 shown in FIG. 3).

At 402, historical financial data, historical portfolio data, and historical value parameters data associated with a plurality of customers is retrieved. The historical financial data, historical portfolio data, and historical value parameters data associated with a plurality of customers may be retrieved from one or more databases, such as database 106 shown in FIG. 1. Value parameters data may include data associated with a customer's goals, risk tolerance, behaviors, and desires. For example, a value parameters may include a numerical value indicating the risk tolerance of the customer.

At 404, the historical financial data, historical portfolio data, and historical value parameters data is used to train a portfolio completion (PC) model. The PC model relates the historical financial data to the historical portfolio data and the historical value parameters data. The PC model predicts a customized portfolio based upon user financial data and user value parameters data. The trained PC model is then stored in a memory device at 406. PC model may be a machine learning (ML) (e.g., artificial intelligence or “AI”) model. For example, in some embodiments, PC model may incorporate a neural network or other machine learning model that makes the necessary adjustments to improve the accuracy of the customized portfolio computation. Therefore, the disclosed systems and methods enable the generation of a customized portfolio for a customer in real-time and in accordance with their current financial data and their values.

At 408, current customer financial data and current customer value parameter data associated with a customer is retrieved from a memory. Next, at 410, a customized allocation portfolio is generated for the customer using the PCT model based upon the received current customer financial data and current customer value parameter data.

In some embodiments, the customized allocation portfolio is transmitted to at least one third party. The customized allocation portfolio may be automatically transmitted to at least one third party or may be transmitted to the at least one third party upon the customer's request. The at least one third party may comprise at least one of a bank, a financial institution, a financial advisor, and a credit card company.

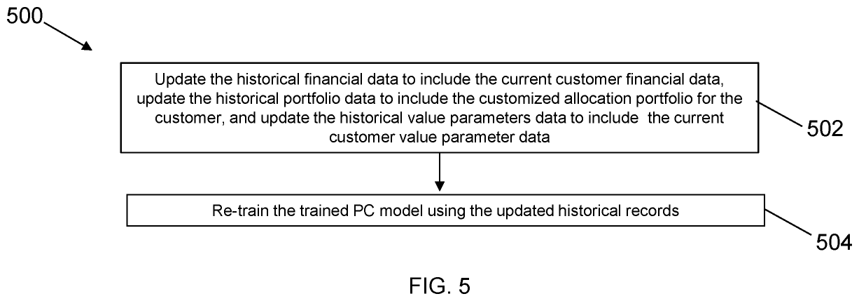

FIG. 5 depicts a flow diagram of an exemplary process for re-training the PC model 500. Process 500 may be a computer-implemented process performed by one or more processors (e.g., processor 206 shown in FIG. 2 and/or processor 304 shown in FIG. 3). The process for re-training the PC model 500 may be performed after process 400 is complete. At 502, the historical financial data is updated to include the current customer financial data, the historical portfolio data is updated to include the customized allocation portfolio for the customer, and the historical value parameters data is updated to include the current customer value parameter data. Next, at 504, the trained PC model is re-trained using the updated historical records (i.e., the updated historical financial data, the updated historical portfolio data, and the updated historical value parameters).

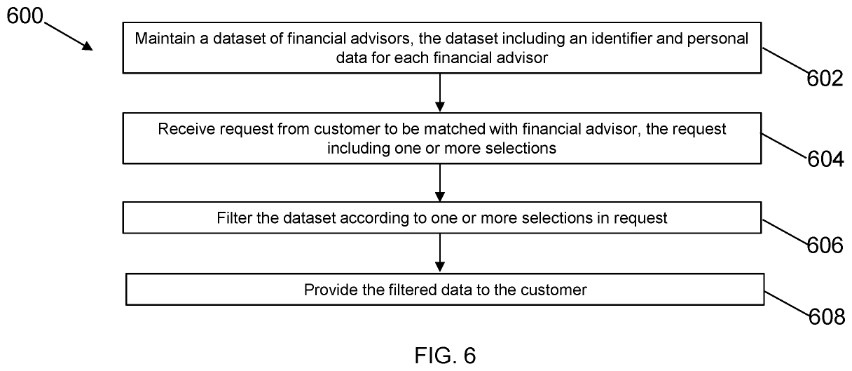

FIG. 6 depicts a flow diagram of an exemplary process for matching the customer with a financial advisor 600. In some embodiments, matching process 600 may occur after process 400 is complete. Process 600 may be a computer-implemented process performed by one or more processors (e.g., processor 206 shown in FIG. 2 and/or processor 304 shown in FIG. 3).

At 602, a dataset of financial advisors is maintained. The dataset may include an identifier and personal data associated with each financial advisor. The personal data may include, but is not limited to, ethics, focus, reputation, and/or location of the financial advisor. Financial advisors and/or personal data associated with a financial advisor may be added and removed in maintaining the dataset.

At 604, a request from customer to be matched with financial advisor is received. In further embodiments, the request includes one or more selections. For example, the one or more selections may comprise desirable characteristics for a financial advisor, including, but not limited to ethics, focus, reputation, and/or location.

At 606, the dataset is filtered according to the customer's one or more selections in the request. For example, if the customer requested a reputable financial advisor located in Philadelphia, Pennsylvania, the dataset may be filtered for financial advisors located in Philadelphia, Pennsylvania with five-star reviews on a financial advisor rating site. Additionally, or alternatively, the dataset is filtered based on current customer financial data, current customer value parameter data associated with a customer, and/or the customized allocated portfolio generated for the customer. For example, if the customer is an ultra-high-net-worth individual, the dataset will be filtered for financial advisors with experience in managing ultra-high-net-worth individuals.

Next, at 608, the filtered data is presented to the customer. For example, a list of financial advisors and their location and reputation matching the selections of the customer may be presented to the customer. In some embodiments, the presentation of the list of financial information includes a scheduler, contact information, and the like, which enable the customer to contact and/or set up a meeting with a financial advisor of interest.

Although matching process 600 is discussed with regards to matching a customer to a financial advisor, matching process 600 may also be used to match a customer with a bank, a financial institution, and/or a credit card company. For example, matching process 600 may comprise maintaining a database of financial institutions, the database comprising an identifier and data associated with the financial institution, receiving a request from a customer to be matched with a financial institution, the request including one or more selections, filtering the financial institution database according to the one or more selections, and providing the filtered data to the customer so the customer may easily select a financial advisor in alignment with their goals and desires.

In response to a customer selecting a financial advisor, a financial institution, or the like, the customer's customized allocation portfolio may be automatically sent to the selected financial advisor, financial institution, etc.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as images, object statistics and information, audio and/or video records, text, and/or actual true or false values. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

As described above, the systems and methods described herein may use machine learning, for example, for pattern recognition. That is, machine learning algorithms may be used by computing device 102, for example, to identify patterns between initial and subsequent feedback provided by entities, such as clients or agencies, and in view of recommendations made by the computing device 102. Accordingly, the systems and methods described herein may use machine learning algorithms for both pattern recognition and predictive modeling.

### Additional Considerations

The computer-implemented methods discussed herein may include additional, less, or alternate actions, including those discussed elsewhere herein. The methods may be implemented via one or more local or remote processors, transceivers, servers, and/or sensors (such as processors, transceivers, servers, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A portfolio completion (PC) computing device comprising at least one processor in communication with a memory device, the at least one processor configured to:
retrieve, from the memory device, historical financial data, historical value parameters data, and historical portfolio data associated with a plurality of customers;
train a PC model relating the historical financial data to the historical portfolio data and the historical value parameters data, wherein the PC model predicts a customized portfolio based upon user financial data and user value parameters data;
store the trained PC model in the memory device;
receive customer financial data and customer value parameter data associated with a customer; and
predict a customized allocation portfolio for the customer using the trained PC model based upon the received customer financial data and customer value parameter data.

2. The PC computing device of claim 1, wherein the at least one processor is further configured to:
update the historical financial data to include the current customer financial data, update the historical portfolio data to include the customized allocation portfolio for the customer, and update the historical value parameters data to include the current customer value parameter data; and
re-train the trained PC model using the updated historical financial data, the updated historical portfolio data, and the updated historical value parameters data.

3. The PC computing device of claim 1, wherein the at least one processor is further configured to:
transmit the predicted customized allocation portfolio to at least one third party.

4. The PC computing device of claim 3, wherein the at least one third party is at least one of a bank, a financial institution, a financial advisor, and a credit card company.

5. The PC computing device of claim 1, wherein the at least one processor is further configured to:
maintain a dataset of financial advisors, the dataset including an identifier and personal data for each financial advisor.

6. The PC computing device of claim 5, wherein the at least one processor is further configured to:
receive a request from customer to be matched with financial advisor, the request including one or more selections;
filter the dataset according to one or more selections in request; and
provide the filtered data to the customer.

7. The PC computing device of claim 1, wherein the customized allocation portfolio comprises an investment strategy for one or more assets of the customer.

8. A computer-implemented method for generating a customized allocation portfolio, the method implemented using a system including a portfolio completion (PC) computing device including a processor communicatively coupled to a memory device, the method comprising:
retrieving, from the memory device, historical financial data, historical value parameters data, and historical portfolio data associated with a plurality of customers;
training a PC model relating the historical financial data to the historical portfolio data and the historical value parameters data, wherein the PC model predicts a customized portfolio based upon user financial data and user value parameters data;
storing the trained PC model in the memory device;
receiving customer financial data and customer value parameter data associated with a customer; and
predicting a customized allocation portfolio for the customer using the trained PC model based upon the received customer financial data and customer value parameter data.

9. The computer-implemented method of claim 8, further comprising:
updating the historical financial data to include the current customer financial data, update the historical portfolio data to include the customized allocation portfolio for the customer, and update the historical value parameters data to include the current customer value parameter data; and
re-training the trained PC model using the updated historical financial data, the updated historical portfolio data, and the updated historical value parameters data.

10. The computer-implemented method of claim 8, further comprising:
transmitting the predicted customized allocation portfolio to at least one third party.

11. The computer-implemented method of claim 10, wherein the at least one third party is at least one of a bank, a financial institution, a financial advisor, and a credit card company.

12. The computer-implemented method of claim 8, further comprising:
maintaining a dataset of financial advisors, the dataset including an identifier and personal data for each financial advisor.

13. The computer-implemented method of claim 12, further comprising:
receiving a request from customer to be matched with financial advisor, the request including one or more selections;
filtering the dataset according to one or more selections in request; and
providing the filtered data to the customer.

14. The computer-implemented method of claim 8, wherein the customized allocation portfolio comprises an investment strategy for one or more assets of the customer.

15. At least one non-transitory computer-readable storage medium having computer-executable instructions stored thereon, wherein when executed by a processor of a portfolio completion (PC) computing device, the computer-executable instructions cause the processor to:
retrieve, from the memory device, historical financial data, historical value parameters data, and historical portfolio data associated with a plurality of customers;
train a PC model relating the historical financial data to the historical portfolio data and the historical value parameters data, wherein the PC model predicts a customized portfolio based upon user financial data and user value parameters data;
store the trained PC model in the memory device;
receive customer financial data and customer value parameter data associated with a customer; and
predict a customized allocation portfolio for the customer using the trained PC model based upon the received customer financial data and customer value parameter data.

16. The at least one non-transitory computer-readable storage medium of claim 15, wherein the instructions further cause the processor to:
update the historical financial data to include the current customer financial data, update the historical portfolio data to include the customized allocation portfolio for the customer, and update the historical value parameters data to include the current customer value parameter data; and
re-train the trained PC model using the updated historical financial data, the updated historical portfolio data, and the updated historical value parameters data.

17. The at least one non-transitory computer-readable storage medium of claim 15, wherein the instructions further cause the processor to:
transmit the predicted customized allocation portfolio to at least one third party.

18. The at least one non-transitory computer-readable storage medium of claim 17, wherein the at least one third party is at least one of a bank, a financial institution, a financial advisor, and a credit card company.

19. The at least one non-transitory computer-readable storage medium of claim 15, wherein the instructions further cause the processor to:
maintain a dataset of financial advisors, the dataset including an identifier and personal data for each financial advisor.

20. The at least one non-transitory computer-readable storage medium of claim 19, wherein the instructions further cause the processor to:
receive a request from customer to be matched with financial advisor, the request including one or more selections;
filter the dataset according to one or more selections in request; and
provide the filtered data to the customer.
